(19) United States
(12) Patent Application Publication
(10) Pub. No.: US 2009/0026407 A1
(43) Pub. Date: Jan. 29, 2009

(54) ADHESIVE MATERIALS

(75) Inventors: Michael Ralph Tomlinson, Sheffield (GB); Mark Geoghegan, Sheffield (GB); Rita La Spina, Sheffield (GB)

Correspondence Address: TROUTMAN SANDERS LLP, 600 PEACHTREE STREET , NE, ATLANTA, GA, 30308, US

(73) Assignee: The University of Sheffield, Sheffield (GB)

(21) Appl. No.: 11/961,606

(22) Filed: Dec. 20, 2007

(30) Foreign Application Priority Data
Jul. 23, 2007 (GB) 0714326.6

(51) Int. Cl. H01G 9/028

(52) U.S. Cl. 252/62.2

(57) ABSTRACT

A reversibly adhesive combination comprising a first component having a first surface and a second component having a second surface, the respective components being adhesively attachable when said surfaces are in contact and the combination is subject to environmental conditions of a first type and the components being separable when the combination is subject to environmental conditions of a second type wherein the first and second components respectively comprise oppositely charged polyelectrolytes. Typically the polyelectrolytes are respectively a polyacid and a polybase. Typically the environmental conditions are represented by pH.

### BENEFIT CLAIM

This application is based on, and claims the benefit of priority to, UK application GB 0714326.6., filed 23 Jul. 2007, which priority application is hereby incorporated by reference.

### BACKGROUND OF THE INVENTION

1. Field of the invention

The present disclosure relates to adhesive materials. More especially the present disclosure relates to combinations of materials, and to the individual materials forming such combinations, which are adhesive and in which the adhesion can be reversed, reduced or released by changes in the environment to which the materials are subjected. In particular, the disclosure relates to polymeric materials and their combinations demonstrating such properties.

2. Description of Related Art

So-called polymer brushes are well known and comprise a substrate, such as a silicon substrate, onto which a polymer is grafted. Thus the polymer molecules are typically “tethered” at one end to the substrate. The resulting structure has some resemblance to a brush, with the tethered molecules resembling the bristles. It is possible to consider the interaction of such a polymer brush with another polymer network which is in the molten state. Adhesion between the polymer brush and the molten polymer can occur through enthalpic interactions which force the “brush” elements (i.e. tethered polymer molecules) into the gel as well as the entropy of the brush as it maximises its conformations by forming a random or self-avoiding walk structure. The polymer moieties forming the brush thus become entangled between fixed cross-links so that the only way in which the brush and the polymer network can be separated and disentangled would be for the brush to diffuse along its own contour. This is prohibited, more especially as all the other grafted polymer moieties of the brush would have to disentangle at the same time. It follows that the only way to overcome the adhesion of the brush and the polymer network is to break bonds. This would render subsequent re-adhesion impossible.

Certain polymeric materials, of which hydrogels and polyelectrolytes are notable examples, can change their properties in response to their environment. Thus, a hydrogel may, in good solvent conditions, swell by greater than an order of magnitude as compared with its dry state. Polyelectrolytes in aqueous solution can adopt different conformations, and may also have different affinities for other molecules and surfaces, according to their environment, for example a transition to and from an extended hydrophilic state and a collapsed hydrophobic state.

### BRIEF SUMMARY OF THE INVENTION

The present disclosure seeks to harness such properties to provide materials which, when in contacting relation are adherent in environmental conditions of a first type and which are non-adherent, or at least less adherent, when in environmental conditions of a second type.

According to the disclosure there is provided a reversibly adhesive combination comprising a first component having a first surface and a second component having a second surface, the respective components being adhesively attachable when said surfaces are in contact and the combination is subject to environmental conditions of a first type and the components being separable when the combination is subject to environmental conditions of a second type, wherein at least one of the first and second components comprises a charged polyelectrolyte.

In one embodiment the first and second components respectively comprise oppositely charged electrolytes.

In one variation of this embodiment at least one of the polyelectrolytes is a weak polyelectrolyte. In another variation the first and second polyelectrolytes are weak polyelectrolytes.

In another embodiment, one of the first and second components is a polyelectrolyte, such as a weak polyelectrolyte, and the other of the first and second components is a charged surface. For example, the charged surface may be a surface of a substrate which acts as a weak acid in an aqueous environment. An example of this is a native oxide layer formed on a silicon substrate in water which includes a proportion of —OH functionality. In an aqueous environment, the proton may be lost, leaving negatively charged oxygen. Other surfaces may be positively charged, sapphire being one example.

In further embodiments the polyelectrolytes are respectively a polyacid and a polybase. Specifically, the polyelectrolytes may respectively be weak polyacids and weak polybases.

Where the polyelectrolyte is a polybase, the basic functionality thereof may, for example, be obtained through the inclusion of one or more functional groups selected from primary amines, secondary amines, tertiary amines, primary amides, secondary amides, tertiary amides, primary imines, secondary imines and pyridine derivatives.

Where the polyelectrolyte is a polyacid, the acidic functionality thereof may, for example, be obtained through the inclusion of one or more functional groups selected from carboxylic acids, thiol groups and phenol groups.

In embodiments the polybase according to the present disclosure can in principle be prepared from any suitable combination of two or more polymers or of two or more monomer units, such as random copolymers, graft copolymers, block copolymers, star polymers and the like which include one or more weak base groups. Similarly, in some embodiments the polyacid according to the present disclosure can in principle be prepared from any combination of two or more polymers or of two or more monomer units, such as random copolymers, graft copolymers, block copolymers, star polymers and the like which include one or more acid base groups.

In the present specification, a weak polyacid can usefully be considered to be a polymer having acid functional groups which, in aqueous media, are not wholly ionised (by release of a proton). In other words, in aqueous media ionised and non ionised acid groups exist in equilibrium and the position of the equilibrium can be affected by the pH of the aqueous medium. Similarly, a weak polybase can usefully be considered to be a polymer having basic functional groups which, in aqueous media, are not wholly ionised (by addition of a proton). In other words, in aqueous media ionised and non ionised basic groups exist in equilibrium and the position of the equilibrium can be affected by the pH of the aqueous medium.

Examples of suitable polybases include poly(dimethylaminoethyl methacrylate), poly(diethylaminoethyl methacrylate), poly(imidazole), poly(vinyl pyridine), polyamidoamines and poly(ethylene imine).

Examples of suitable polyacids include poly(methacrylic acid), poly(acrylic acid) and poly(2,6 dinitro 6 ethylene phenol).

The environmental conditions of the first and second types may usefully comprise respective pH values or pH ranges. It is noted that the boundary or threshold which separates the environmental conditions in which the polyelectrolytes are adherent and the environmental conditions in which the polyelectrolytes are non-adherent or separable may not necessarily be sharply defined. For example, where the environmental conditions are represented by pH, the adhesion between the respective polyelectrolytes may progressively or gradually reduce (or, respectively, increase) over a pH range.

In alternative embodiments the environmental conditions may, for example, be salt concentration.

The inventors have further appreciated that the boundary or threshold at which the polyelectrolytes change from being adherent to being separable or non-adherent can be adjusted by varying the composition of the or each polyelectrolyte. In particular, said boundary can be adjusted by incorporating into the polyelectrolyte a substantially neutral co-monomer. Preferably such co-monomer is biocompatible. Examples of such co-monomers can include ethylene glycol, 2-hydroxyethylmethacrylate, ethylene glycol monomethacrylate and 2-methacryloyloxyethyl phosphorylcholine (MPC) (Formula (I)).

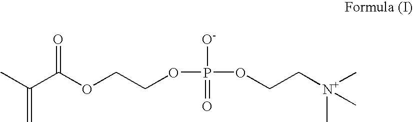

In some configurations, the components of the combination are separable when the pH of the environment is lowered to below a threshold value.

In some other configurations, the components of the combination are separable when the pH of the environment is raised to above a threshold value.

In further configurations the first component comprises a substrate having the polyelectrolyte attached thereto.

The polyelectrolyte attached to the substrate may be a polybase.

In further embodiments the first component may comprise a polymer brush.

Where the polyelectrolyte is a base, the polyelectrolyte of the first component may be a nitrogen-containing base.

In further embodiments the basic moiety of the polyelectrolyte of the first component may be an amine moiety.

Said basic moiety may be a secondary or tertiary amine group.

The polybase may be poly(2-dimethylamino)ethylmethacrylate.

Where the polyelectrolyte is a polyacid, the polyacid may comprise carboxylic acid moieties.

In some configurations, the polyacid is derived from an acrylic acid moiety.

In further configurations the polyacid is derived from a methacrylic acid moiety.

The polyacid may be polymethacrylic acid (PMAA).

### BRIEF DESCRIPTION OF THE DRAWINGS

For a better understanding of the disclosure and to show how the same may be carried into effect, reference will be made to the following drawings, in which:

FIG. 1 is a schematic representation of an apparatus useful for determining adhesion of the first and second components of the disclosure;

FIG. 2 is a graph illustrating work of adhesion as a function of compressive stress at three different pH values;

FIG. 3 is a graph showing the variation of contact diameter and pH value with time; and

FIG. 4 shows neutron reflectrometry data illustrating the volume-fraction depth-profile for PMMA gel in contact with PDMAEMA brush and for the PDMAEMA brush in the absence of the PMMA gel.

### DETAILED DESCRIPTION OF THE PREFERRED EMBODIMENTS

The following example is illustrative of the disclosure. In the example, interactions between a polymer brush consisting of PDMAEMA (poly(dimethylamino)ethyl methacrylate) grafted onto a silicon surface with a PMMA (poly(methacrylic acid)) gel are described.

Materials

PDMAEMA brushes were synthesised using atom transfer radical polymerisation (ATRP) on a silicon substrate using a procedure similar to that described for PDEAEMA brushes by P D Topham et al in Polym. Int. 2006, 55, 808. However Cu(II)Br₂ was added at the beginning of the reaction to induce more controlled ATRP. The [11-(2-bromo-2-methyl)propionyloxy]undecyl trichlorosilane initiator layer was allowed to equilibrate overnight on the surface of a toluene solution to maximise surface coverage. The brush molecular weight was not directly measured but can reasonably be estimated by assuming a grafting density of 0.5 brushes nm⁻², which is reasonable in the experimental conditions, and a monomer density of 0.93 gcc⁻¹. This provides, for a 20 nm film, a molecular mass of 22.4 kDa. This molecular mass scales linearly with brush thickness. For a uniform distribution of molecular initiator, a low polydispersity index is assured when, as in the present case, the films are of uniform thickness.

PMMA gel was synthesised by free radical cross linking 32% (w/w) methacrylic acid with 0.5% (w/w) N,N′-methylenebisacrylamide by using 0.6% (w/w) 2,2′-azobis(2methylpropionamidine) dihydrochloride as catalyst in aqueous solution. The resulting gels are highly cross-linked with a factor of 123-more methacrylic acid monomers to methylene bisacrylamide cross-linker in the solution. If the cross linking were perfect, this would correspond to an average of 62 monomers between cross links and the gel would be highly heterogeneous.

Quantification Methods and Results

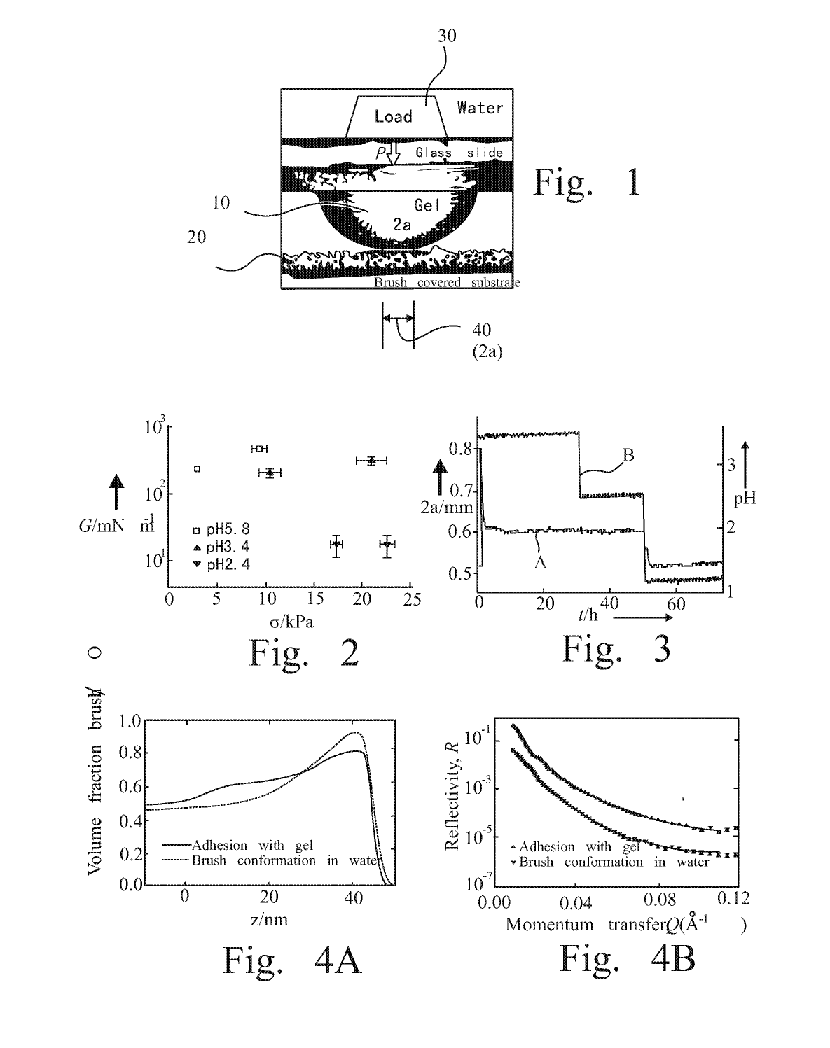

In general terms, the brush (PDMAEMA) and gel (PMMA) are equilibrated in water and then brought into contact. The equilibration is initially about pH 7. Adhesion between the brush and the gel was found. To quantify the level of adhesion, a modified version of a Johnson-Kendall-Roberts (JKR) experiment was used. Aspects of the experimental set-up for this determination are shown in FIG. 1. The JKR technique is useful in this context for directly probing the adhesion at the interface between the brush and the gel, in contrast to other methods which measure adherence which is also dependant on the bulk material properties. For the JKR method, the PMMA gel is formed as a hemisphere by using a hemispherical mould. The hemispherical sample 10 of the PMMA gel is placed in contact with the PDMAEMA brush substrate 20. The gel is then subjected to a load 30 which acts to compress the gel which thus varies the contact radius (40) (=2a) between the gel 10 and the brush substrate 20 in accordance with the applied load. The load can also affect the degree of ionisation within the gel hemisphere. The contact radius before, during and after loading is noted at equilibrium. On unloading, the energy required to open the interface between the gel and the brush substrate can be determined, yielding the work of adhesion, G. More specifically, G is the static crack propagation energy, which is the energy required to separate the gel 10 from the brush substrate 20. The JKR equation is:

$${a}^{3} = \frac{R}{K} ( P + 3 π GR + \sqrt{6 π GRP + {( 3 π GR )}^{2}} ) \qquad ( 1 )$$

In Equation 1, a is the contact radius of the gel hemisphere on the brush substrate, R is the radius of curvature of the gel hemisphere, K is the bulk modulus of the gel hemisphere, and P is the load applied to the hemisphere gel. In order to determine the modulus, the Hertz equation is used:

PR=Ka³ (2)

By measuring the contact radius of the gel hemisphere on an unmodified silicon substrate, for which the gel has negligible adhesion, Equation (1) reduces to Equation (2) and the bulk modulus K of the gel can be determined. It is thus possible to make measurements of the bulk modulus K as a function of pH value and further to measure the work of adhesion, G also as a function of pH. (It is noted in this respect that if the pH value is changed the bulk properties (swelling and modulus) of the gel change

Thus, by means of the experimental procedure described above, it is possible directly to probe the interaction between the PMMA gel and the PDMAEMA brush at the interface between the two materials. Such investigation shows that the energy required to separate the PMMA gel from the PDMAEMA brush is a function of the applied load. The inventors believe that this suggests that the work of adhesion is pressure sensitive. Another way of illustrating the obtained data is to take into account the pressure effect by plotting the work of adhesion G as a function of the compressive stress σ at the point where the JKR measurement determines the adhesion, which is the circular contact line (with the brush substrate) of radius a_{f} that the gel relaxes to when the load is removed. The compressive stress is given by the Equation (3):

$$σ ( {a}_{f} ) = \sqrt{\frac{3 {a}_{1} {KG}_{0}}{2 π ( {a}_{l}^{2} - {a}_{f}^{2} )}} - \frac{3 K \sqrt{{a}_{1}^{2} - {a}_{f}^{2}}}{2 π R} \qquad ( 3 )$$

In which G₀ is the work of adhesion measured before any load is applied and a₁ is the equilibrium contact radius after the load is applied. The results obtained for the PMMA gel and PDMAEMA brush combination are illustrated in FIG. 2, showing the variation in the value of G at two different applied loads (32 mN and 60 mN) and three different pH values, namely 2.4, 3.4 and 5.8. It will be appreciated from FIG. 2 that the work of adhesion G varies by a factor of 30. Moreover, the largest measured value, 442 mNm⁻¹, is less than an order of magnitude less than values obtained from JKR measurements with a silanated glass (D L Woerdeman et al Composites Part A 1999 30, 95) and is comparable with results on model soft adhesives (H R Brown, Macromolecules, 1993, 26, 1666). In other words, the adhesion obtained between the PMMA gel and the PDMAEMA brush is at least approaching that of epoxy materials which are known for their high adhesion.

The inventors have further established that the adhesion demonstrated above is reversible, or switchable, dependent on the environmental conditions and in particular on pH. Reference is made in this respect to FIG. 3 which illustrates the variation in contact diameter 2a (as described in relation to FIG. 1) (line A) and also pH (line B) as a function of time. Thus, using the apparatus described in relation to FIG. 1, the value 2a was measured as the pH value was lowered. Initially the pH was 3.4 and in a first stage the pH value was reduced to 2.4. As can be seen from FIG. 3, this change in pH value does not lead to any significant change in the contact diameter. Thus for this change in pH value, it can be seen that there is no significant change in the adhesion between the PMMA gel and the PDMAEMA brush. However, when the pH is further reduced to about pH 1.1, the contact diameter changes significantly from about 0.6 mm to about 0.5 mm. This shows a reduction in the adhesion between the PMMA gel and the PDMAEMA brush. At this pH value and level of adhesion, the gel may be safely removed from the brush, allowing re-use.

After separation of the PMMA gel and the PDMAEMA brush, the two can be re-adhered to re-form their combination by bringing them into contact at a pH value greater than about 3. Then process of separation and re-adhesion allowed by the variation of pH can be repeated several times, for example at least six times.

In the case of the above PMMA/PDMAEMA combination, the time taken for the components to separate at low pH values depends on the applied load. Thus, in the case of the largest work of adhesion measured initially at pH 5.8, the separation required up to three days at pH 1.1 whereas a time as short as 7 hours may be required for smaller loads.

Further details of the interaction between the PMMA gel and the PDMAEMA brush have been explored using neutron reflectometry experiments. For these experiments, the PDMAEMA brush is pressed lightly into contact with the PMMA gel at pH 7. The PDMAEMA brush is synthesised from a deuterated monomer to provide contrast with the non-deuterated PMMA gel and the solution in H₂O. The results are shown in FIGS. 4A and 4B. FIG. 4A illustrates the reflectivity data and the brush-volume fraction Φ-depth profile z. These results reveal that the brush is not extended at its extremity, but rather has a sharp interface with the gel. Without wishing to be bound by any particular theory, the inventors postulate that, although it would be difficult to eliminate the possibility that the brush is also entangled within the gel, the profile of the brush without the gel is also shown and is similar, suggesting that the dominant contribution to the interaction between the brush and the gel is at the interface between them. In FIG. 4B the corresponding reflectivity R data and fit as a function of neutron momentum transfer wavevector Q for a deuterated PDMAEMA brush in contact with PMMA gel at pH 7 are shown. The quality of the fit is excellent with a χ² value of approximately 1. In FIG. 4A, the solid line represents the adhesion between the PMMA gel and the PDMAEMA brush and the dashed line represents the PDMAEMA brush in water (that is, absent the PMMA gel). In FIG. 4B, the adhesion between the PMMA gel and the PDMAEMA brush is represented by ▴ and the PDMAEMA brush in water is represented by ▾.

As noted the inventors postulate that the results in FIG. 4 suggest that, at least at small loads, there is no interpenetration between the PMMA gel and the PDMAEMA brush. The inventors suggest, again without wishing to be bound by theory, that the origin of the adhesion between the PMMA gel and the PDMAEMA brush may lie in a mixture of electrostatic interactions between opposite charges as well as hydrogen bonding between amine groups of the PDMAEMA and carboxylic groups of the PMMA. This would also agree with the reversibility of the adhesion. The inventors believe that, at larger loads, the gel may be interpenetrated by the brush, which suggests that the interpenetration of the gel by the brush, which then entangles within the gel, may be a significant factor contributing to the adhesion at higher loads.

Thus the inventors have provided reversibly adhesive components in which the combination is adhered at pH values of between 3 and at least 7 with higher adhesion at higher pH values. At pH values of less than about 2, the adhesion fails and the components may be disconnected.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the disclosure are to be understood to be applicable to any other aspect, embodiment or example described herein unless incompatible therewith.

We claim:

1. A reversibly adhesive combination comprising a first component having a first surface and a second component having a second surface, the respective components being adhesively attachable when said surfaces are in contact and the combination is subject to environmental conditions of a first type and the components being separable when the combination is subject to environmental conditions of a second type wherein at least one of the first and second components comprises a charged polyelectrolytes.

2. A combination as claimed in claim 1 wherein the first and second components respectively comprise oppositely charged electrolytes.

3. A combination as claimed in claim 1 wherein the at least one of the polyelectrolytes is a weak polyelectrolyte.

4. A combination as claimed in claim 2 wherein the first and second polyelectrolytes are weak polyelectrolytes.

5. A combination as claimed in claim 3 wherein the first and second polyelectrolytes are weak polyelectrolytes.

6. A combination as claimed in claim 2 wherein the polyelectrolytes are respectively a polyacid and a polybase.

7. A combination as claimed in claim 5 wherein the polyelectrolytes are respectively a polyacid and a polybase.

8. A combination as claimed in claim 6 wherein the basic functionality of the polybase is obtained through the inclusion of one or more functional groups selected from primary amines, secondary amines, tertiary amines, primary amides, secondary amides, tertiary amides, primary imines, secondary imines and pyridine derivatives.

9. A combination as claimed in claim 6 wherein the acidic functionality of the polyacid is obtained through the inclusion of one or more functional groups selected from carboxylic acids, thiol groups and phenol groups.

10. A combination as claimed in claim 1 wherein the or each polyelectrolyte includes a substantially neutral co-monomer.

11. A combination as claimed in any claim 1 wherein the environmental conditions of the first and second types comprise respective pH values or pH ranges.

12. A combination as claimed in any claim 7 wherein the environmental conditions of the first and second types comprise respective pH values or pH ranges.

13. A combination as claimed in claim 11 wherein the components of the combination are separable when the pH of the environment is lowered to below a threshold value.

14. A combination as claimed in claim 11 wherein the components of the combination are separable when the pH of the environment is raised to above a threshold value.

15. A combination as claimed in claim 1 wherein the first component comprises a substrate having the polyelectrolyte attached thereto.

16. A combination as claimed in claim 2 wherein the first component comprises a substrate having the polyelectrolyte attached thereto.

17. A combination as claimed in claim 16 wherein the polyelectrolyte attached to the substrate is a polybase.

18. A combination as claimed in claim 16 wherein the first component comprises a polymer brush.

19. A combination as claimed in claim 6 wherein the polyelectrolyte of the first component is a nitrogen-containing base.

20. A combination as claimed in claim 19 wherein the basic moiety of the polyelectrolyte of the first component is an amine moiety.

21. A combination as claimed in claim 20 wherein said basic moiety is a secondary or tertiary amine group.

22. A combination as claimed in claim 6 wherein the polybase is poly(2-dimethylamino)ethylmethacrylate.

23. A combination as claimed in claim 6 wherein the polyacid comprises carboxylic acid moieties.

24. A combination as claimed in claim 6 wherein the polyacid is derived from an acrylic acid moiety.

25. A combination as claimed in claim 6 wherein the polyacid is derived from a methacrylic acid moiety.

26. A combination as claimed in claim 6 wherein the polyacid is polymethacrylic acid (PMAA).

27. A combination as claimed in claim 22 wherein the polyacid is polymethacrylic acid (PMAA).

28. A combination as claimed in claim 1 wherein one of the first and second components is a polyelectrolyte, and the other of the first and second components is a charged surface.

29. A combination as claimed in claim 28 herein the polyelectrolyte is a weak polyelectrolyte.
